(19) United States
(12) Patent Application Publication
(10) Pub. No.: US 2025/0189378 A1
(43) Pub. Date: Jun. 12, 2025

(54) TESTING DEVICE FOR MULTI-CALORIC EFFECTS

(71) Applicant: XIANGTAN UNIVERSITY, Xiangtan (CN)

(72) Inventors: Yunya LIU, Xiangtan (CN); Da ZU, Xiangtan (CN); Dongliang SHAN, Xiangtan (CN)

(73) Assignee: XIANGTAN UNIVERSITY, Xiangtan (CN)

(21) Appl. No.: 18/970,992

(22) Filed: Dec. 6, 2024

(30) Foreign Application Priority Data
Dec. 6, 2023 (CN) 202311663938.7

(51) Int. Cl. G01J 5/02; G01J 5/00

(52) U.S. Cl. CPC G01J 5/026; G01J 5/0255; G01J 2005/0077

(57) ABSTRACT

A testing device for multi-caloric effects in the solid-state cooling technology includes a dynamic magnetic field application assembly, a stress application assembly, a pulse voltage application assembly, and an infrared thermal imaging temperature acquisition assembly. In the dynamic magnetic field application assembly, permanent magnetic holding devices hold permanent magnets, which are slidably mounted on the first guide rail, with two permanent magnets positioned parallel to each other at a distance. The stress application assembly is located between the two first guide rails. The sample is clamped between the first and second sample clamps, and the pulse voltage application assembly is connected to the electrode plates of the sample clamps via wires. The advantages are that it allows for the application of stress, electric fields, and magnetic fields to solid materials, individually or simultaneously, and enables the non-destructive collection of temperature changes in the sample.

### CROSS REFERENCE TO THE RELATED APPLICATIONS

This application is based upon and claims priority to Chinese Patent Application No. 202311663938.7, filed on Dec. 6, 2023, the entire contents of which are incorporated herein by reference.

### TECHNICAL FIELD

The present invention pertains to solid-state cooling technology, specifically related to a testing device for multi-caloric effects.

### BACKGROUND

With the continuous intensification of global warming, the demand for refrigeration has been steadily increasing. Efficient and climate-friendly cooling is crucial to the climate and sustainable development puzzle. Due to high energy efficiency, potential for miniaturization, and without refrigerants, solid-state cooling technology has become a strong candidate for the next generation of refrigeration devices.

Solid-state cooling technology relies on the reversible changes in temperature and entropic states of intrinsic order parameters in solid materials under the influence of one or more physical fields, achieving refrigeration through a thermodynamic cycle. Caloric materials responsive to magnetic, electric, or stress fields are termed magnetocaloric, electrocaloric, or mechanocaloric, respectively. Solid-state cooling technologies driven by a single physical field have been extensively studied and have shown great application potential. However, due to the low power and efficiency of solid-state cooling under a single physical field, it fails to meet the requirements for the industrial application of solid-state cooling technology. When subjected to different physical field excitations, solid materials with multi-field coupling characteristics typically exhibit caloric effects corresponding to these different physical fields, known as multi-caloric effects. For example, magnetoelectric materials can simultaneously exhibit magnetocaloric and electrocaloric effects, demonstrating multi-caloric effects. In caloric materials, different types of external fields can produce different thermal responses. This property can be used to reduce the significantly harmful hysteresis effects in solid-state cooling cycles. Additionally, suppose the coupling between different order parameters is sufficiently strong. In that case, a single type of external stimulus can simultaneously produce multi-caloric effects, potentially enhancing the solid-state cooling performance of the caloric material. Therefore, multi-caloric effects are expected to solve the problems of low cooling power and efficiency in traditional solid-state cooling technology. This could further promote the development of solid-state cooling technology, accelerate its replacement of traditional compression-based cooling technology, and help mitigate the trend of global warming.

Despite the significant application potential of multi-caloric effects in the field of refrigeration, the lack of specialized characterization equipment and direct methods to characterize multi-caloric effects has led to slow research progress in this area, hindering the application of caloric materials. Currently, some multi-field application devices used in scientific research typically provide only small external fields and cannot simultaneously measure multiple caloric effects. In particular, there is currently no device capable of measuring multi-caloric effects. Therefore, it is urgent to develop a system capable of simultaneously loading/unloading multi-physical fields such as force, electric, and magnetic fields, as well as developing a testing system and method for multi-caloric effects.

### SUMMARY

The objective of the embodiments of the present invention is to invent a testing device for multi-caloric effects, aiming to solve the problems in existing caloric effect characterization technologies, such as the lack of simultaneous loading/unloading of multiple physical fields and synchronous temperature acquisition.

To achieve the above objective, the technical solution adopted by the present invention is: providing a testing device for multi-caloric effects, including: a dynamic magnetic field application assembly, a stress application assembly, a pulse voltage application assembly, and an infrared thermal imaging temperature acquisition assembly.

The dynamic magnetic field application assembly includes a first linear reciprocating device, a first guide rail, permanent magnet holding devices, and permanent magnets. Two parallel first guide rails are set apart from each other. Two permanent magnet holding devices are provided and are slidably arranged on the first guide rails, each permanent magnet holding device being equipped with a permanent magnet. The first linear reciprocating device drives the two permanent magnet-holding devices to move synchronously in a reciprocating motion.

The stress application assembly includes a second linear reciprocating device, a second guide rail, a first sample clamp, and a second sample clamp. The first sample clamp and the second sample clamp each hold one end of the sample. The second guide rail is positioned between the two first guide rails. The first sample clamp is slidably mounted on the second guide rail, while the second sample clamp is fixed at one end of the second guide rail. The second linear reciprocating device drives the first sample clamp to reciprocate.

The pulse voltage application assembly includes a high-voltage amplifier, a pulse-pattern generator, and a photoelectric sensor. The pulse-pattern generator is used to generate pulse waves, which are connected to the high-voltage amplifier to produce pulse voltages. The pulse voltages are applied to the electrode plates of the first and second sample clamps. The photoelectric sensor is used to trigger the pulse-pattern generator and detect the movement of the first sample clamp.

The infrared thermal imaging temperature acquisition assembly is used to collect information on temperature variation in the sample surface.

In one embodiment, the test device for multi-caloric effects includes a temperature control assembly. The temperature control assembly includes an insulation chamber, a temperature supply assembly, and a dehumidification assembly. The dynamic magnetic field application assembly, the stress application assembly, the photoelectric sensor, and the infrared thermal imaging temperature acquisition assembly are all located within the insulation chamber.

In one embodiment, the temperature supply assembly includes a temperature controller, a heater, a cooler, a heater temperature sensor, and a cooler temperature sensor. The dehumidification assembly includes a dehumidifier and a humidity sensor.

In one embodiment, the first linear reciprocating device includes a mounting bracket, a vertical plate, a drive motor, a swinging connecting rod, a reciprocating telescopic rod, and a connecting frame. The vertical plate is vertically fixed by the mounting bracket. The drive motor is mounted on the vertical plate, and the drive motor is connected to the swinging connecting rod for transmission. The swinging connecting rod is connected to the reciprocating telescopic rod for transmission. The reciprocating telescopic rod is connected to the connecting frame for transmission. The connecting frame is connected to the two permanent magnet-holding devices.

In one embodiment, the first guide rail is a cylindrical linear guide rail, and the permanent magnet-holding devices are slidably mounted on the cylindrical linear guide rail using a slider. The permanent magnet holding devices include a mounting frame and a spacing adjustment bracket. The mounting frame is fixedly installed with the permanent magnet, and the spacing adjustment bracket is adjustably connected to the mounting frame. The spacing adjustment bracket is fixed to the slider via an L-shaped bracket. Between the two mounting frames is a length-adjustable high magnetic permeability bracket.

In one embodiment, the second linear reciprocating device includes a servo motor, a support seat, a screw rod, and a programmable logic controller (PLC) automatic control system. The PLC automatic control system is electrically connected to the servo motor. The support scat is used for rotatably mounting the screw rod. The servo motor is drivingly connected to the screw rod, which is positioned above the second guide rail. The first sample clamp is threadedly connected to the screw rod via a slider and is slidably set on the second guide rail.

In one embodiment, the first sample clamp and the second sample clamp are both E-shaped structures with openings facing each other. Both the first and second sample clamps hold the sample using two knob screws.

In one embodiment, the testing device for the multi-caloric effects further includes a sensor assembly. The sensor assembly includes a first time relay, a second time relay, a first proximity sensor, and a second proximity sensor. The first proximity sensor is mounted on the upright plate via a fixed bracket and detects the extension distance of the reciprocating telescopic rod. The second proximity sensor is fixed on the baseplate through a support frame. The first sample clamp is equipped with a metal baffle mounted via a connecting plate and can be detected by the second proximity sensor. The first time relay is electrically connected to the second proximity sensor and the second time relay, and the second time relay is electrically connected to the drive motor.

In one embodiment, the infrared thermal imaging temperature acquisition assembly includes an infrared thermal imaging camera, a camera stand, and a computer. The camera stand is capable of vertical adjustment and horizontal extension. The infrared thermal imaging camera is mounted on the camera stand and is electrically connected to the computer. The photoelectric sensor is mounted on an adjustable bracket.

In one embodiment, the permanent magnet-holding devices, the first sample clamp, and the second sample clamp are all made of non-magnetic materials.

The beneficial effects of the testing device for the multi-caloric effect provided by this invention are:

First, through the coordinated use of the dynamic magnetic field application assembly, the stress application assembly, the pulsed voltage application assembly, and the infrared thermal imaging temperature acquisition assembly, it is possible to configure various stress fields, electric fields, magnetic fields, and temperature conditions on the sample held by the sample fixture. This setup also allows for data collection and monitoring of the sample, thereby enabling the characterization of the sample's multi-caloric effects.

Second, by incorporating the temperature control assembly, the insulation chamber not only provides a stable environmental temperature for the sample but also creates a sealed space around it. In this enclosed testing environment, convective heat transfer between the sample and the external air is prevented during the characterization of the sample's multi-caloric effects, significantly enhancing the accuracy and precision of the test. Additionally, the temperature control assembly can provide various environmental temperatures, making the setup suitable for characterizing the caloric effects of different materials and extending the measurement range.

### BRIEF DESCRIPTION OF THE DRAWINGS

To clarify the technical solutions in the embodiments of the present invention, the following provides a brief introduction to the drawings used in the embodiments or the description of the prior art. It is evident that the drawings described below are merely some embodiments of the present invention. Those skilled in the art may obtain other drawings based on these illustrations without inventive efforts.

FIG. 1 is a schematic diagram of the overall structure of the testing device for multi- caloric effects according to the embodiment of the present invention.

FIG. 2 is a schematic diagram of the internal structure of the insulation chamber in the testing device for multi-caloric effects according to the embodiment of the present invention.

FIG. 3 is a top-view schematic diagram of the structure of the insulation chamber in the testing device for multi-caloric effects according to the embodiment of the present invention.

FIG. 4 is a schematic diagram of the structure of the dynamic magnetic field application assembly in the testing device for multi-caloric effects according to the embodiment of the present invention.

FIG. 5 is a schematic diagram of the two permanent magnet-holding devices in the testing device for multi-caloric effects according to the embodiment of the present invention.

FIG. 6 is a schematic diagram of the stress application assembly structure in the testing device for multi-caloric effects according to the embodiment of the present invention.

FIG. 7 is a schematic diagram of the structure of the first and second sample clamps in the testing device for multi-caloric effects according to the embodiment of the present invention.

FIG. 8 is a schematic diagram of the installation of the infrared thermal imaging temperature acquisition assembly and the photoelectric sensor in the testing device for multi-caloric effects according to the embodiment of the present invention.

FIG. 9 is a schematic diagram of the adjustable bracket installation for the photoelectric sensor in the testing device for multi-caloric effects provided by the embodiment of the present invention.

FIG. 10 is a curve showing the variation of temperature over time after characterizing the electrocaloric effect of a P(VDF-TrFE-CTFE) polymer using a multi-caloric effect testing device provided by the embodiment of the present invention.

FIG. 11 is a curve showing the variation of temperature over time after characterizing the elastocaloric effect of SEBS rubber using a multi-caloric effect testing device provided by the embodiment of the present invention.

FIG. 12 is a curve showing the variation of temperature over time after characterizing the magnetocaloric effect of gadolinium metal using a multi-caloric effect testing device provided by the embodiment of the present invention.

In which the reference marks in the drawings are:
1. Temperature control assembly; 11. Insulation chamber; 111. Baseplate; 12. Temperature supply assembly; 121. Temperature controller; 122. Heater; 123. Cooler; 124. Heater temperature sensor; 125. Cooler temperature sensor; 13. Dehumidification assembly; 131. Dehumidifier; 132. Humidity sensor; 2. Dynamic magnetic field application assembly; 21. First linear reciprocating device; 211. Mounting bracket; 212. Vertical plate; 213. Drive motor; 214. Swing connecting rod; 215. Reciprocating telescopic rod; 216. Connecting frame; 22. First guide rail; 23. Permanent magnet holding device; 231. Mounting frame; 232. Spacing adjustment bracket; 233. High magnetic permeability bracket; 24. Permanent magnet; 25. L-shaped bracket; 3. Stress application assembly; 31. Second linear reciprocating device; 311. Servo motor; 312. Support seat; 313. Screw rod; 32. Second guide rail; 33. First sample clamp; 34. Second sample clamp; 35. Knob screw; 36. Servo motor power supply; 37. Connecting plate; 38. Metal baffle; 4. Sensor assembly; 41. First time relay; 42. Second time relay; 43. First proximity sensor; 44. Second proximity sensor; 5. Infrared thermal imaging temperature acquisition assembly; 51. Infrared thermal imaging camera; 52. Camera stand; 53. Computer; 6. Main power; 7. PLC automatic control system; 8. Pulse voltage application assembly; 81. High-voltage amplifier; 82. Pulse-pattern generator; 83. Photoelectric sensor; 84. Adjustable bracket.

### DETAILED DESCRIPTION OF THE EMBODIMENTS

In order to make the technical problems, technical solutions, and beneficial effects that the present invention aims to address clearer, the invention will be further described in detail below with reference to the accompanying drawings and embodiments. It should be understood that the specific embodiments described herein are provided solely for the purpose of illustrating the invention and are not intended to limit its scope.

It should be noted that when an element is described as being “fixed” or “disposed” of another element, it can be either directly on the other element or indirectly on it. When an element is described as being “connected to” another element, it may be directly connected to the other element or indirectly connected to it.

It should be understood that terms such as “length,” “width,” “upper,” “lower,” “front,” “rear,” “left,” “right,” “vertical,” “horizontal,” “top,” “bottom,” “inner,” “outer,” and other similar terms indicating orientations or positional relationships are based on the orientations or positional relationships shown in the drawings. They are provided solely for the convenience of describing the invention and simplifying the description. They are not intended to indicate or imply that the referenced devices or elements must have a specific orientation, be constructed in a specific orientation, or operate in a specific orientation. Therefore, these terms should not be construed as limiting the scope of the present invention.

Furthermore, the terms “first” and “second” are used solely for descriptive purposes and should not be interpreted as indicating or implying relative importance or suggesting the number of the referenced technical features. Therefore, features described as “first” or “second” may explicitly or implicitly include one or more of these features. In the context of this description, “multiple” means two or more, unless otherwise explicitly defined.

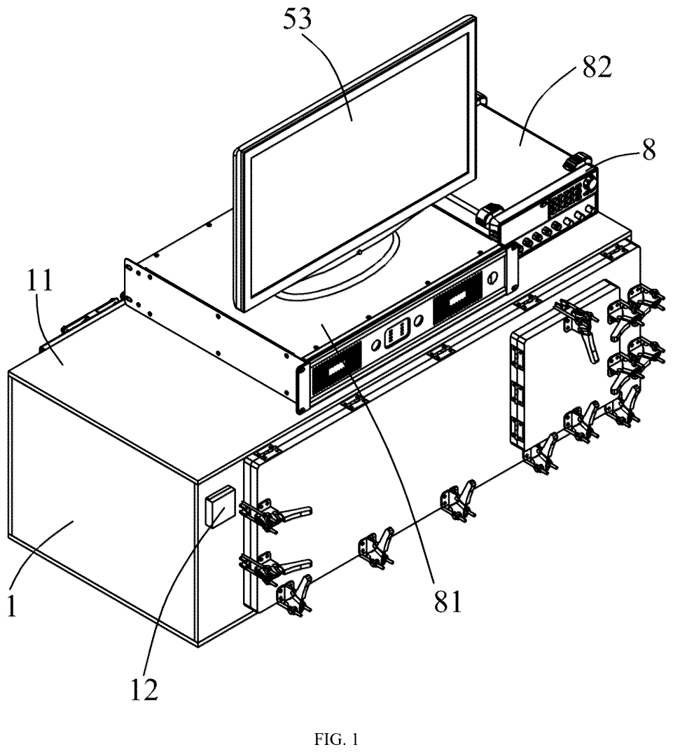

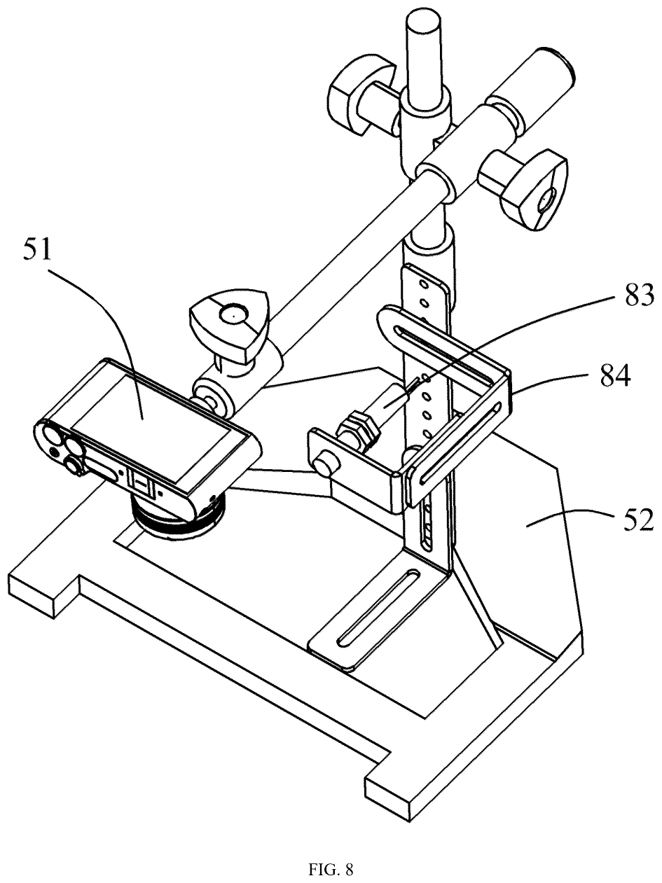

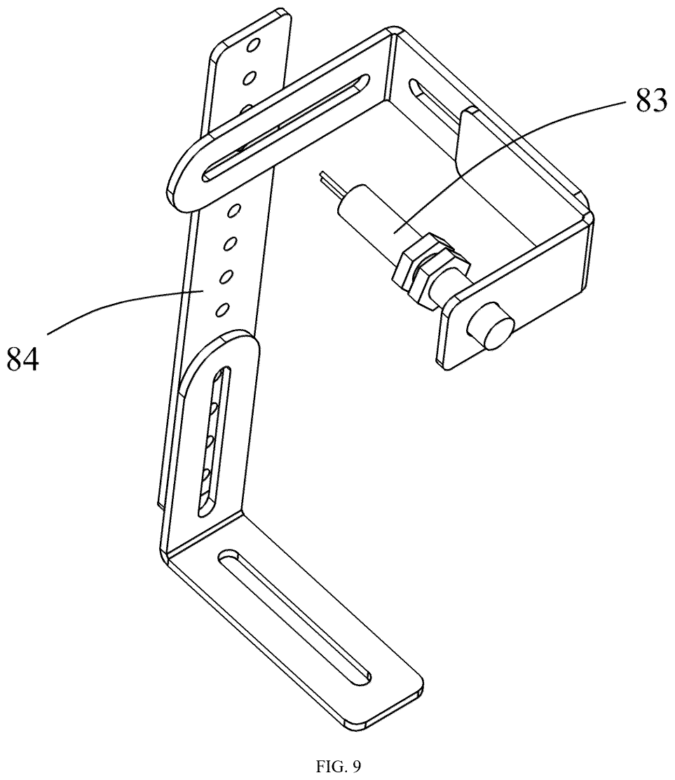

As shown in FIGS. 1-9, the testing device for multi-caloric effects provided in the embodiments of the present invention is now described.

Specifically, the testing device's multi-caloric effects include a dynamic magnetic field application assembly (2), a stress application assembly (3), a pulse voltage application assembly (8), a temperature control assembly (1), and an infrared thermal imaging temperature acquisition assembly (5).

The temperature control assembly (1) includes an insulation chamber (11), a temperature supply assembly (12), and a dehumidification assembly (13). The temperature control assembly (1) is used to provide a stable temperature environment. The dynamic magnetic field application assembly (2) and the stress application assembly (3) are installed on the baseplate (111) of the insulation chamber (11).

The dynamic magnetic field application assembly (2) includes a first linear reciprocating device (21), first guide rails (22), permanent magnet holding devices (23), and permanent magnets (24). The first guide rails (22) are arranged in parallel with two spaced apart. Two permanent magnet holding devices (23) are provided, each slidingly positioned on the first guide rails (22). Each permanent magnet-holding device (23) is equipped with a permanent magnet (24). The first linear reciprocating device (21) drives the two permanent magnet-holding devices (23) to move synchronously back and forth. The two permanent magnets (24) are used to apply a magnetic field; when the two permanent magnets (24) move to both sides of the sample, a magnetic field is applied to the sample. When the permanent magnets (24) move away from the sample, the magnetic field is unloaded.

The stress application assembly (3) includes a second linear reciprocating device (31), second guide rails (32), a first sample clamp (33), and a second sample clamp (34). The first sample clamp (33) and the second sample clamp (34) hold both ends of the sample, respectively. The second guide rails (32) are positioned between the two first guide rails (22) and are parallel to them. The first sample clamp (33) is slidably mounted on the second guide rails (32), while the second sample clamp (34) is fixed at one end of the second guide rails (32). The second linear reciprocating device (31) drives the first sample clamp (33) to move back and forth. When the first sample clamp (33) and the second sample clamp (34) hold the sample, and stress needs to be applied, the second linear reciprocating device (31) drives the first sample clamp (33) to move away from the second sample clamp (34), thereby applying uniaxial tensile stress to the sample. The first sample clamp (33) and the second sample clamp (34) are positioned between the two permanent magnet holding devices (23), allowing the permanent magnet holding devices (23) to apply or unload the magnetic field on the sample under the drive of the first linear reciprocating device (21).

The pulse voltage application assembly (8) includes a high-voltage amplifier (81), a pulse-pattern generator (82), and a photoelectric sensor (83). The pulse-pattern generator (82) is used to generate pulse waves, which are connected to the high-voltage amplifier (81) to produce pulse voltages. The pulse voltage is applied to the electrode plates on the first sample clamp (33) and the second sample clamp (34). The photoelectric sensor (83) is used to trigger the pulse-pattern generator (82) and detect the movement of the first sample clamp (33). The photoelectric sensor (83) is mounted on the baseplate (111) via an adjustable bracket (84), which allows for vertical and horizontal adjustment. This setup positions the photoelectric sensor (83) on the side of the first sample clamp (33) to detect its movement and trigger the pulse pattern generator (82) accordingly. Once triggered, the pulse-pattern generator (82) generates pulse waves, which are connected to the high-voltage amplifier (81) to produce pulse voltages. These pulse voltages are then input to the electrode plates on the first sample clamp (33) and the second sample clamp (34) to apply an electric field to the sample. The electrode plates are located on the top or bottom of the sample clamps.

The infrared thermal imaging temperature acquisition assembly (5) is used to collect temperature variation information of the sample. Specifically, the infrared thermal imaging temperature acquisition assembly (5) includes an infrared thermal imaging camera (51), a camera stand (52), and a computer (53). The computer (53) serves as the storage center. The camera stand (52) is mounted on the baseplate (111) and is a cross-shaped telescopic bracket that can be adjusted vertically and horizontally. This facilitates the adjustment of the position of the infrared thermal imaging camera (51). The infrared thermal imaging camera (51) is mounted on the camera stand (52) and electrically connected to the computer (53). The infrared thermal imaging camera (51) collects temperature variation information of the sample and transmits this information to the computer (53) for storage, facilitating subsequent analysis.

In this embodiment, the servo motor (311) drives the movement of the first sample clamp (33), which can trigger the photoelectric sensor (83), thereby enabling the pulse voltage application assembly (8) to apply an electric field to the sample. Additionally, the servo motor (311) drives the first sample clamp (33) to move away from the second sample clamp (34), providing the stress required during loading.

Precisely, in this embodiment, the dynamic magnetic field application assembly (2), the stress application assembly (3), the photoelectric sensor (83), and the infrared thermal imaging temperature acquisition assembly (5) are all positioned inside the insulation chamber (11), thereby ensuring the accuracy of the testing.

The temperature supply assembly (12) includes a temperature controller (121), a heater (122), a cooler (123), a heater temperature sensor (124), and a cooler temperature sensor (125). The dehumidification assembly (13) consists of a dehumidifier (131) and a humidity sensor (132). Both the temperature supply assembly (12) and the dehumidification assembly (13) are mounted on the side walls of the insulation chamber (11). The dynamic magnetic field application assembly (2), the stress application assembly (3), the photoelectric sensor (83), and the infrared thermal imaging temperature acquisition assembly (5) are all positioned on the baseplate (111) of the insulation chamber (11). The temperature controller (121) regulates the heater (122) and the cooler (123). The heater (122) and cooler (123) operate under the detection of the heater temperature sensor (124) and the cooler temperature sensor (125) to maintain temperature stability within the insulation chamber (11). The dehumidification assembly (13) adjusts the humidity levels inside the insulation chamber (11). In this embodiment, the front of the insulation chamber (11) features a door that can be opened and closed, facilitating sample replacement.

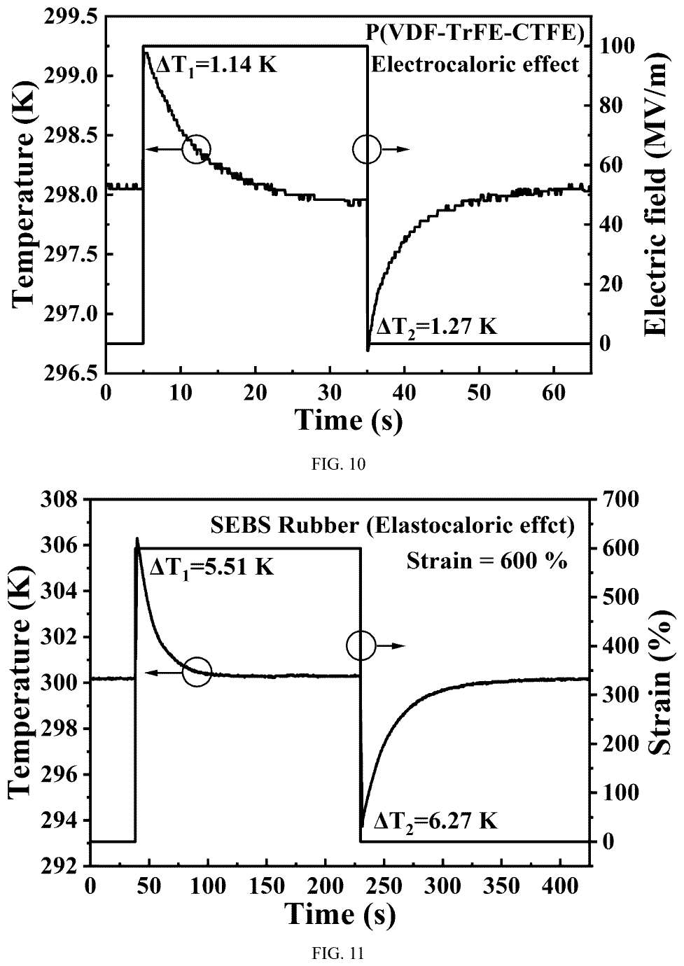

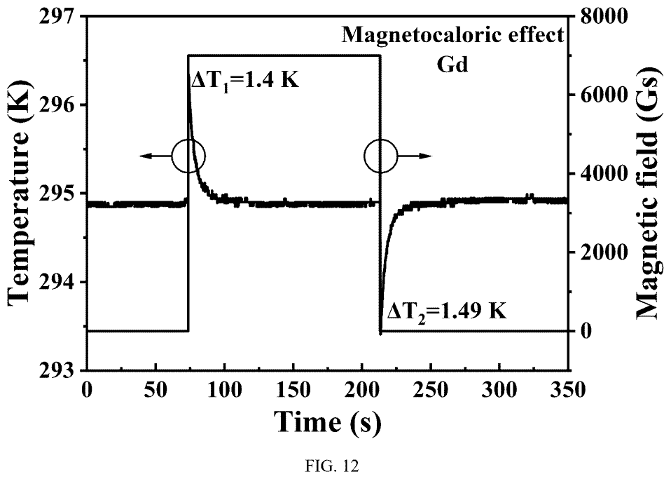

In this embodiment, the pulse voltage application assembly (8), the dynamic magnetic field application assembly (2), and the stress application assembly (3) can be used individually or in combinations of two or all three simultaneously to apply or unload electric fields, magnetic fields, and stress fields on the sample. The temperature variation information of the sample during these processes is measured and stored by the infrared thermal imaging temperature acquisition assembly (5), thereby directly characterizing the material's multi-caloric effects. Specific examples of different materials' caloric effects characterized using this device can be referenced in FIGS. 10-12.

In this embodiment, as shown in FIGS. 5-7, the first linear reciprocating device (21) includes a mounting bracket (211), a vertical plate (212), a drive motor (213), a swing connecting rod (214), a reciprocating telescopic rod (215), and a connecting frame (216). The vertical plate (212) is fixed to the baseplate (111) through the mounting bracket (211). The drive motor (213) is mounted on the vertical plate (212) and is drivingly connected to the swing connecting rod (214). The swing connecting rod (214) is drivingly connected to the reciprocating telescopic rod (215), which is horizontally movable on the vertical plate (212). The reciprocating telescopic rod (215) is drivingly connected to the connecting frame (216), which is connected to the two permanent magnet-holding devices (23). Specifically, the drive motor (213) drives the swing connecting rod (214) to rotate and oscillate through a belt pulley and timing belt system. As the swing connecting rod (214) rotates and oscillates, it pushes the reciprocating telescopic rod (215) to move horizontally left and right, thereby causing the connecting frame (216) to drive the two permanent magnet holding devices (23) to perform a reciprocating motion.

In this embodiment, the first guide rail (22) is a cylindrical linear guide rail, and the permanent magnet holding devices (23) are mounted to slide on the cylindrical linear guide rail via sliders. Each cylindrical linear guide rail is equipped with two sliders: one slider is used to mount the permanent magnet holding devices (23), and both sliders are used to mount the connecting frame (216). The connecting frame (216) has an overall U-shaped structure, with its side plates mounted on the sliders and its middle plate connected to the reciprocating telescopic rod (215).

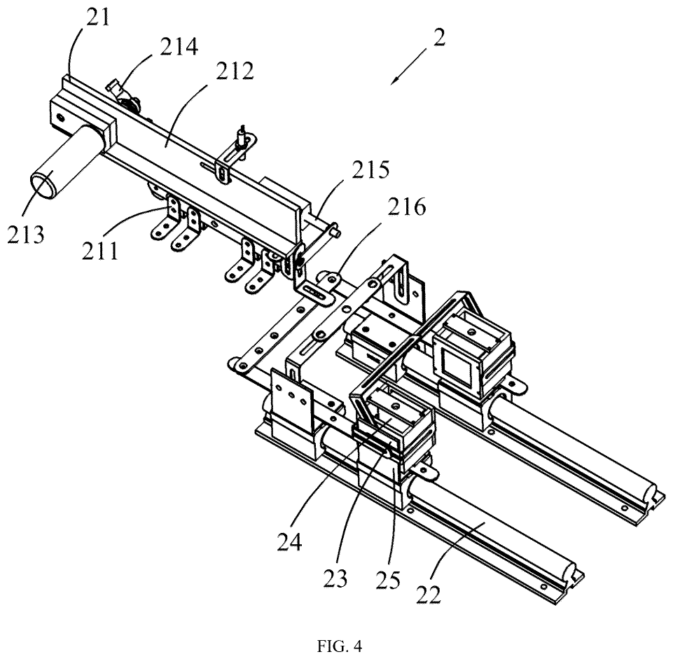

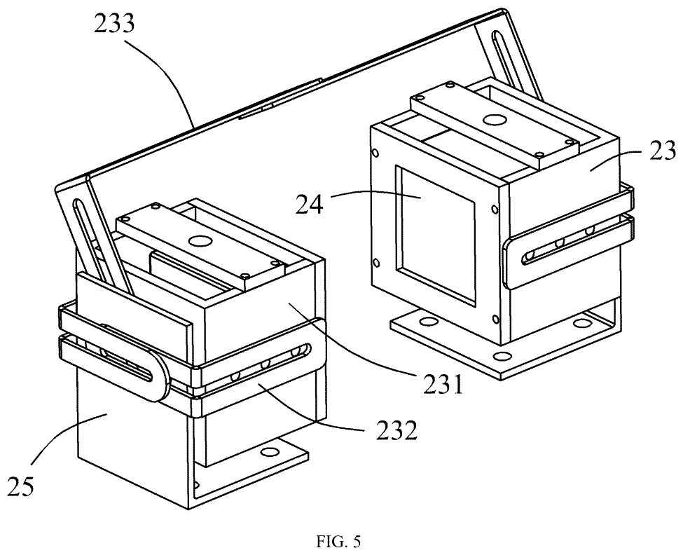

As shown in FIGS. 4-5, in this embodiment, the permanent magnet holding device (23) includes a mounting frame (231) and a spacing adjustment bracket (232). The mounting frame (231) is used to hold the permanent magnet (24) and secure its position. The permanent magnet (24) spacing adjustment bracket (232) has a U-shaped structure, and the mounting frame (231) is placed inside the spacing adjustment bracket (232). The sides of the mounting frame (231) are equipped with spaced mounting holes, allowing the adjustment of the distance between the two mounting frames (231), which in turn enables the adjustment of the magnetic field intensity between the two permanent magnets (24). The spacing adjustment bracket (232) is composed of two L-shaped plates that form a U-shaped structure. These plates partially overlap, and the overlapping section is fixed to the slider on the first guide rail (22) using an L-shaped bracket (25). The sides of the two mounting frames (231) that are closest to each other have openings, which help to reduce interference with the magnetic field formed between the two permanent magnets (24). The height of the sample is positioned at the midpoint of the permanent magnets (24). To ensure magnetic field strength, an adjustable-length high magnetic permeability bracket (233) is placed between the two mounting frames (231). The length of the high magnetic permeability bracket (233) adjusts in sync with the spacing between the two mounting frames (231). The high magnetic permeability bracket (233) consists of two L-shaped silicon steel strips with overlapping areas and long slots for spacing adjustment. They are secured with fastening bolts. The high magnetic permeability bracket (233) confines the magnetic induction lines between the two permanent magnets (24), thereby increasing the magnetic field strength.

In this embodiment, the permanent magnets (24) are cubic blocks, specifically made of neodymium-iron-boron magnets. The magnetic field strength applied by the permanent magnets (24) ranges from 0.5 to 1.0 T, and the magnetic field direction is perpendicular to the direction of the reciprocating motion of the permanent magnets (24). The permanent magnet-holding devices (23) are made of non-magnetic materials to prevent interference with the magnetic field.

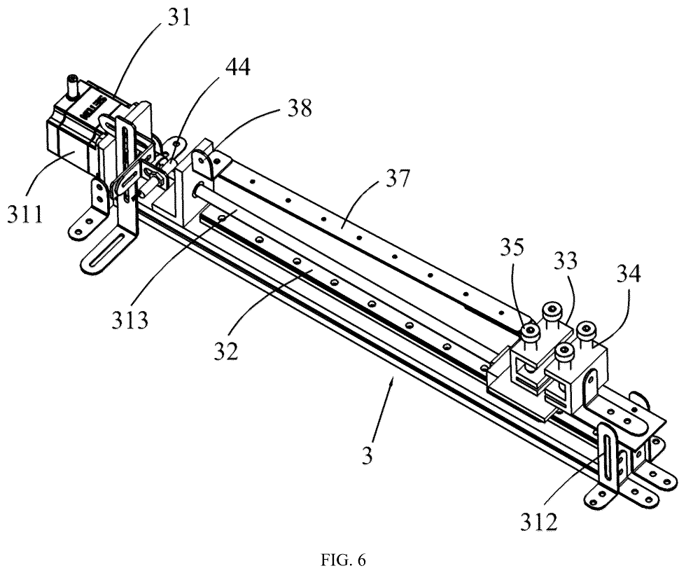

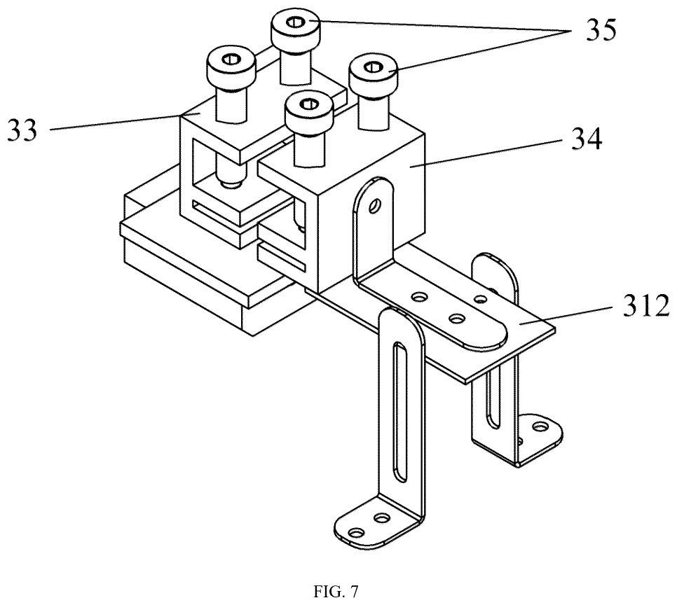

As shown in FIGS. 6-7, in this embodiment, the second linear reciprocating device (31) includes a servo motor (311), a support seat (312), and a screw rod (313). The servo motor (311) is mounted on the baseplate (111), and the support seat (312) is also mounted on the baseplate (111) to provide rotational support for the screw rod (313). The second sample clamp (34) is also installed on the support seat (312). The servo motor (311) is connected to the screw rod (313) through a coupling, and the screw rod (313) is positioned above the second guide rail (32), which reduces the distance between the two permanent magnets (24). The first sample clamp (33) is threadedly connected to the screw rod (313) via a slider and is slidably mounted on the second guide rail (32). When the servo motor (311) operates, it drives the screw rod (313) to rotate. As the screw rod (313) rotates, it moves the slider back and forth along the second guide rail (32), thereby causing the first sample clamp (33) to move reciprocally. When the first sample clamp (33) moves away from the second sample clamp (34), uniaxial stress is applied, and when it moves closer to the second sample clamp (34), the stress is released.

As shown in FIG. 7, both the first sample clamp (33) and the second sample clamp (34) have an E-shaped structure with opposing openings. Both specimen holders are equipped with two knob screws (35) for clamping the specimen, which facilitates easy specimen replacement while ensuring a secure grip. In this embodiment, the first and second sample clamps (33 and 34) are made from non-magnetic materials to avoid interfering with the magnetic field.

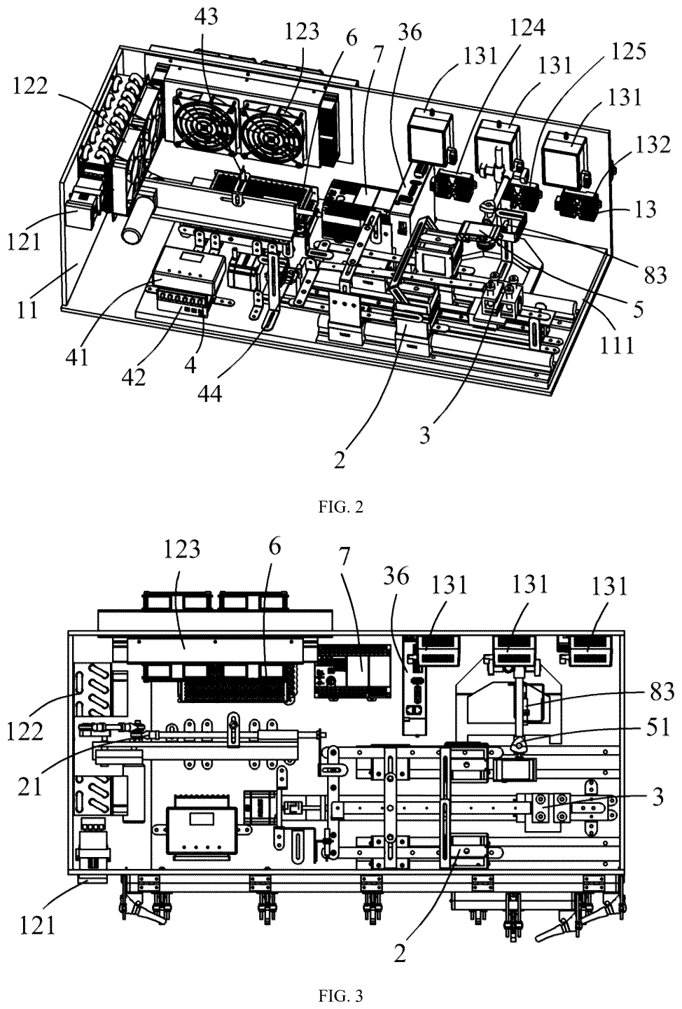

As shown in FIGS. 2-6, in this embodiment, the sensor assembly (4) includes a first time relay (41), a second time relay (42), a first proximity sensor (43), and a second proximity sensor (44). The first proximity sensor (43) is mounted on the vertical plate (212) via a mounting bracket and detects the extension length of the reciprocating telescopic rod (215) to control its extension distance. The second proximity sensor (44) is fixed on the baseplate (111) using a support frame. The first sample clamp (33) is equipped with a metal baffle (38) via a connecting plate (37), where the metal baffle (38) can be detected by the second proximity sensor (44). The metal baffle (38) moves synchronously with the first sample clamp (33). When the first sample clamp (33) moves away from the second sample clamp (34) and the second proximity sensor (44) detects the metal baffle (38), it sends a sensing signal to the first time relay (41). The first time relay (41) is electrically connected to the second proximity sensor (44) and the second time relay (42). The second time relay (42) is electrically connected to the drive motor (213), which controls the operation of the first linear reciprocating device (21) to load or unload the magnetic field on the specimen. The first time relay (41) and the second time relay (42) are used to control the loading/unloading time. Specifically, when the metal baffle (38) on the first sample clamp (33) makes contact with the second proximity sensor (44), the first time relay (41) is triggered. The first time relay (41) is connected to the second time relay (42), and its triggering powers the second time relay (42). The second time relay (42) controls the operating duration of the drive motor (213). It monitors the extension distance of the reciprocating telescopic rod (215) via the first proximity sensor (43), thereby controlling the duration for which the magnetic field is applied to or unloaded from the specimen. Simultaneously, the first time relay (41) works in conjunction with the second proximity sensor (44) and, under the control of the PLC automatic control system (7), manages the operating status of the servo motor (311) to regulate the stress application time.

During the force-electric-magnetic synchronized loading test, the servo motor (311) operates to drive the first sample clamp (33) to move away from the second sample clamp (34) via the screw rod (313). When the movement of the first sample clamp (33) is detected by the photoelectric sensor (83), it triggers the high-voltage amplifier (81) and the pulse-pattern generator (82), thereby applying an electric field to the specimen through the first and second sample clamps (33 and 34). Simultaneously, the movement of the first sample clamp (33) also drives the connecting plate (37) and metal baffle (38) to move in sync. When the metal baffle (38) is detected by the second proximity sensor (44), it triggers the first time relay (41), which in turn triggers the second time relay (42). This activation triggers the drive motor (213) to operate, causing the reciprocating telescopic rod (215) to extend and retract, thereby moving the permanent magnet holding devices (23) and permanent magnets (24) to apply a magnetic field to the sample.

A main power (6) and a servo motor power supply (36) are also installed on the baseplate (111) for power supply. Additionally, a PLC automatic control system (7) is set up on the baseplate (111) as the control center, used to manage information such as loading/unloading time, number of cycles, loading speed, and strain magnitude.

In this embodiment, the PLC automatic control system (7) can control the maximum movement distance of the first sample clamp (33) to 300 mm, the minimum movement distance to 0.01 mm, and the maximum movement speed to 1000 mm/s.

In this embodiment, the infrared thermal imaging camera (51) is positioned directly above the sample to achieve non-destructive acquisition of the sample's temperature information.

In this embodiment, the testing device for multi-caloric effects can simultaneously apply and remove any single or multiple physical fields with simple operation, non-destructive effects on the sample, and high testing accuracy. By using the stress application assembly (3), pulse voltage application assembly (8), dynamic magnetic field application assembly (2), temperature control assembly (1), and infrared thermal imaging temperature acquisition assembly (5) in coordination, the device can configure various stress fields, electric fields, magnetic fields, and temperatures for different samples. Additionally, the infrared thermal imaging temperature acquisition assembly (5) provides real-time collection and monitoring of the sample's temperature variation information, thereby directly characterizing the sample's multi-caloric effects. For specific examples, please refer to FIGS. 10-12.

At the same time, the design of the insulation chamber (11) reduces thermal exchange between the gases inside the chamber and the external environment, preventing convective heat transfer between the sample and the outside air, thus minimizing temperature measurement errors. Additionally, the temperature control assembly (1) can regulate the temperature inside the insulation chamber (11), providing a wide range of test temperatures suitable for materials with different Curie temperatures. Moreover, the pulse voltage application assembly (8) can deliver pulse voltages up to 10 kV, and the dynamic magnetic field application assembly (2) can adjust the magnetic field strength by varying the distance between the two permanent magnets (24), offering diverse options for magnetic field strength application. This allows for a broader testing range and effective integration of multi-caloric effects.

In this embodiment, the testing device can individually or simultaneously apply and remove multiple physical fields to solid materials, including stress, electric, and magnetic fields. It features a broad measurement range, high-temperature measurement accuracy, and a simple structure, thereby enabling the characterization of the material's multi-caloric effects. The above description is merely an example of the implementation of the invention and is not intended to limit the invention. Any modifications, equivalent substitutions, and improvements made within the spirit and principles of the invention should be included within the scope of the invention's protection.

What is claimed is:

1. A testing device for multi-caloric effects, comprising: a dynamic magnetic field application assembly, a stress application assembly, a pulse voltage application assembly, and an infrared thermal imaging temperature acquisition assembly;
wherein the dynamic magnetic field application assembly comprises a first linear reciprocating device, two first guide rails, two permanent magnet holding devices, and permanent magnets; the two first guide rails are set in parallel and apart from each other; the two permanent magnet holding devices are provided and slidably arranged on the two first guide rails, wherein each of the two permanent magnet holding devices has a permanent magnet; and the first linear reciprocating device drives the two permanent magnet holding devices to move synchronously in a reciprocating motion;
the stress application assembly comprises a second linear reciprocating device, a second guide rail, a first sample clamp, and a second sample clamp; the first sample clamp and the second sample clamp hold two ends of a sample, respectively; the second guide rail is located between the two first guide rails; the first sample clamp is slidably arranged on the second guide rail, while the second sample clamp is fixed in place; and the second linear reciprocating device drives the first sample clamp to move reciprocally;
the pulse voltage application assembly comprises a high-voltage amplifier, a pulse-pattern generator, and a photoelectric sensor; the pulse-pattern generator generates pulse waves and is connected to the high-voltage amplifier to produce a pulse voltage; the pulse voltage is applied to electrode plates of the first sample clamp and the second sample clamp; and the photoelectric sensor is used to trigger the pulse-pattern generator and to sense movement of the first sample clamp; and the infrared thermal imaging temperature acquisition assembly is used to collect temperature variation information on a sample surface.

2. The testing device according to claim 1, further comprising a temperature control assembly; wherein the temperature control assembly comprises an insulation chamber, a temperature supply assembly, and a dehumidification assembly; and the dynamic magnetic field application assembly, the stress application assembly, the photoelectric sensor, and the infrared thermal imaging temperature acquisition assembly are all installed inside the insulation chamber.

3. The testing device according to claim 2, wherein the temperature supply assembly comprises a temperature controller, a heater, a cooler, a heater temperature sensor, and a cooler temperature sensor; and the dehumidification assembly comprises a dehumidifier and a humidity sensor.

4. The testing device according to claim 1, wherein the first linear reciprocating device comprises a mounting bracket, a vertical plate, a drive motor, a swing connecting rod, a reciprocating telescopic rod, and a connecting frame; the vertical plate is vertically fixed by the mounting bracket; the drive motor is mounted on the vertical plate, and the drive motor is connected to the swing connecting rod in a drive connection; the swing connecting rod is connected to the reciprocating telescopic rod in the drive connection, and the reciprocating telescopic rod is connected to the connecting frame in the drive connection; and the connecting frame is connected to the two permanent magnet holding devices.

5. The testing device according to claim 4, wherein each of the two first guide rails is a cylindrical linear guide rail, and each of the two permanent magnet holding devices is slidably mounted on the cylindrical linear guide rail via a slider; each of the two permanent magnet holding devices comprises a mounting frame and a spacing adjustment bracket; the permanent magnet is fixedly installed within the mounting frame; the spacing adjustment bracket is connected to the mounting frame and is secured to the slider via an L-shaped bracket; and an adjustable-length high magnetic permeability bracket is provided between two mounting frames.

6. The testing device according to claim 5, wherein the second linear reciprocating device comprises a servo motor, a support seat, a screw rod, and a programmable logic controller (PLC) automatic control system; the PLC automatic control system is electrically connected to the servo motor; the support seat is used for mounting the screw rod; the servo motor is drivingly connected to the screw rod; the screw rod is positioned above the second guide rail, and the first sample clamp is threadedly connected to the screw rod through the slider and is slidably mounted on the second guide rail.

7. The testing device according to claim 6, wherein the first sample clamp and the second sample clamp both have an E-shaped structure, wherein an opening of the first sample clamp and an opening of the second sample clamp face each other; and both the first sample clamp and the second sample clamp hold the sample using two knob screws.

8. The testing device according to claim 7, further comprising a sensor assembly, wherein the sensor assembly comprises a first time relay, a second time relay, a first proximity sensor, and a second proximity sensor; the first proximity sensor is mounted on the vertical plate via a fixed bracket and detects an extension distance of the reciprocating telescopic rod; the second proximity sensor is fixed to a baseplate through a support frame; the first sample clamp is equipped with a metal baffle via a connecting plate, wherein the metal baffle is detected by the second proximity sensor; the first time relay is electrically connected to the second proximity sensor and the second time relay, and the second time relay is electrically connected to the drive motor.

9. The testing device according to claim 1, wherein the infrared thermal imaging temperature acquisition assembly comprises an infrared thermal imaging camera, a camera stand, and a computer; the camera stand is allowed for vertical and horizontal adjustments; the infrared thermal imaging camera is mounted on the camera stand and electrically connected to the computer; and
the photoelectric sensor is mounted on an adjustable bracket.

10. The testing device according to claim 9, wherein the two permanent magnet holding devices, the first sample clamp, and the second sample clamp are all made of non-magnetic materials.

11. The testing device according to claim 2, wherein the infrared thermal imaging temperature acquisition assembly comprises an infrared thermal imaging camera, a camera stand, and a computer; the camera stand is allowed for vertical and horizontal adjustments; the infrared thermal imaging camera is mounted on the camera stand and electrically connected to the computer; and the photoelectric sensor is mounted on an adjustable bracket.

12. The testing device according to claim 3, wherein the infrared thermal imaging temperature acquisition assembly comprises an infrared thermal imaging camera, a camera stand, and a computer; the camera stand is allowed for vertical and horizontal adjustments; the infrared thermal imaging camera is mounted on the camera stand and electrically connected to the computer; and the photoelectric sensor is mounted on an adjustable bracket.

13. The testing device according to claim 4, wherein the infrared thermal imaging temperature acquisition assembly comprises an infrared thermal imaging camera, a camera stand, and a computer; the camera stand is allowed for vertical and horizontal adjustments; the infrared thermal imaging camera is mounted on the camera stand and electrically connected to the computer; and the photoelectric sensor is mounted on an adjustable bracket.

14. The testing device according to claim 5, wherein the infrared thermal imaging temperature acquisition assembly comprises an infrared thermal imaging camera, a camera stand, and a computer; the camera stand is allowed for vertical and horizontal adjustments; the infrared thermal imaging camera is mounted on the camera stand and electrically connected to the computer; and the photoelectric sensor is mounted on an adjustable bracket.

15. The testing device according to claim 6, wherein the infrared thermal imaging temperature acquisition assembly comprises an infrared thermal imaging camera, a camera stand, and a computer; the camera stand is allowed for vertical and horizontal adjustments; the infrared thermal imaging camera is mounted on the camera stand and electrically connected to the computer; and the photoelectric sensor is mounted on an adjustable bracket.

16. The testing device according to claim 7, wherein the infrared thermal imaging temperature acquisition assembly comprises an infrared thermal imaging camera, a camera stand, and a computer; the camera stand is allowed for vertical and horizontal adjustments; the infrared thermal imaging camera is mounted on the camera stand and electrically connected to the computer; and the photoelectric sensor is mounted on an adjustable bracket.

17. The testing device according to claim 8, wherein the infrared thermal imaging temperature acquisition assembly comprises an infrared thermal imaging camera, a camera stand, and a computer; the camera stand is allowed for vertical and horizontal adjustments; the infrared thermal imaging camera is mounted on the camera stand and electrically connected to the computer; and the photoelectric sensor is mounted on an adjustable bracket.

18. The testing device according to claim 11, wherein the two permanent magnet holding devices, the first sample clamp, and the second sample clamp are all made of non-magnetic materials.

19. The testing device according to claim 12, wherein the two permanent magnet holding devices, the first sample clamp, and the second sample clamp are all made of non-magnetic materials.

20. The testing device according to claim 13, wherein the two permanent magnet holding devices, the first sample clamp, and the second sample clamp are all made of non-magnetic materials.
